(19) United States
(12) Patent Application Publication
(10) Pub. No.: US 2012/0106474 A1
(43) Pub. Date: May 3, 2012

(54) BEAMFORMING TRAINING METHODS, APPARATUSES AND SYSTEM FOR A WIRELESS COMMUNICATION SYSTEM

(75) Inventors: Ye WU, Beijing (CN); Yu ZHANG, Beijing (CN); Ming LEI, Beijing (CN)

(73) Assignee: NEC (CHINA ) CO., LTD., Beijing (CN)

(21) Appl. No.: 13/275,772

(22) Filed: Oct. 18, 2011

(30) Foreign Application Priority Data
Oct. 29, 2010 (CN) 201010532180.X

(51) Int. Cl. H04W 16/28

(52) U.S. Cl. 370/329

(57) ABSTRACT

The present invention provides methods and apparatuses for beamforming training at a service and control point and a user station, and a system for beamforming training for a wireless communication system. According to the present invention, a method for beamforming training at a service and control point may comprise: transmitting training sequences to multiple user stations by using switched transmit antenna weight vectors; determining optimum transmit antenna weight vectors of the service and control point based on channel information that is fed back from each user station of the multiple user stations and related to channel condition of own link and cross links of the each user station. According to the present invention, there is provided a spatial-reuse based simultaneous beamforming training technology, which may satisfy the demands of a dense-user application; moreover, has a high spectrum efficiency and saves beamforming training time.

### FIELD OF THE INVENTION

The present invention relates to a wireless communication technology, and more particularly, relates to methods and apparatuses for beamforming training at a service and control point and at a user station, and a system of beamforming training for a wireless communication system.

### BACKGROUND OF THE INVENTION

Beamforming is a diversity technology which sufficiently utilizes multi-antenna arrays. RF beamforming, as one of beamforming technologies, is featured with a lower implementation complexity compared to digital beamforming, and its performance loss is also highly acceptable. However, current RF beamforming related standards, especially 60 GHz ones (e.g. IEEE 802.15.3c, IEEE 802.11ad, wireless HD and WiGig), only employ RF beamforming as a single-stream point-to-point solution. But it usually cannot meet the requirement of concurrent high rate transmission from one point to multiple points in the dense-user cases, e.g. dense sync-and-go applications.

Recent physical (PHY) layer standards of 60 GHz, e.g. Wireless HD, WiGig, IEEE 802.11 ad, all support both single carrier and orthogonal frequency division multiplexing (OFDM) transmission modes. However, from the viewpoint of RF beamforming, the two transmission modes almost have no difference in implementation.

The objective of beamforming training is to obtain optimum transmit antenna weight vectors (TX AWV, also called as transmit beamforming vector) and optimum receive antenna weight vectors (RX AWV, also called as receive beamforming vector) through pre-training, so as to realize an optimum communication between communication stations.

In the IEEE802.11ad standard is disclosed a time division multiplexing access (TDMA) based solution, i.e., a contending one-by-one training method. According to this solution, in a case of the one-to-multiple-user, it is required to perform beamforming training to each user during different periods of time, which is too time consuming, and the spectrum efficiency is quite low.

Additionally, the US patent application US200903189091A1 discloses a system of using a concatenated training sequence for one-to-many simultaneous beamforming training. As illustrated in FIG. 1, in the system, a transmit station 101 first generates a concatenated training sequence composed of n sub training sequences. When each sub sequence is transmitted via a transmit antenna array including multiple antenna units, a unique TX AWV is applied thereto so as to distinguish the phases on the multiple antenna units, such that each sub training sequence as sent out has a unique beam pattern Pi (i=1, . . . , n).

According to the technology as disclosed in this patent, during each period of time, the transmit station transmits one sub training sequence to multiple receive stations (2 in the figure, i.e., receive station 102 and receive station 103) to train the multiple receive stations 102, 103. Then, the multiple receive stations (two in FIG. 2) determine their own optimum TX AWVs based on specific metrics such as capacity, signal-to-noise ration (SNR), etc., and feeds them back to the transmit station.

The plurality of TX AWVs as applied by the transmit station are predetermined, which may be based on a codebook or other rules and are all known to the transmit station and a plurality of trainee receive stations. Thus, the plurality of receive stations may easily feed back their respective optimum TX AWVs.

The above solution is a simultaneous training solution, which solves the time-exhaustive drawback of the TDMA-based training solution to a certain extent, but this solution can only support the TDMA data transmission manner and its data transmission efficiency is still low.

### SUMMARY OF THE INVENTION

In view of the above, the present invention discloses a technical solution of a spatial-reuse based simultaneous beamforming training, so as to solve at least a part of the problems in the prior art.

According to a first aspect of the present invention, there is provided a method for beamforming training at a service and control point. The method may comprise: transmitting training sequences to multiple user stations by using switched transmit antenna weight vectors; determining optimum transmit antenna weight vectors of the service and control point based on channel information that is fed back from each user station of the multiple user stations and related to channel condition of own link and cross links of the each user station.

According to a second aspect of the present invention, there is provided a method for beamforming training at a user station. The method may comprise: receiving training sequences from a service and control point by using a fixed receive antenna weight vector; determining channel information related to channel condition of own link and cross links of the user station; and transmitting the channel information to the service and control point.

According to a third aspect of the present invention, there is provided an apparatus for beamforming training at a service and control point. The apparatus may comprise: training sequence transmission means configured for transmitting training sequences to multiple user stations by using switched transmit antenna weight vectors; and antenna weight determination means configured for determining an optimum transmit antenna weight vectors of the service and control point based on channel information that is fed back from each user station of the multiple user stations and related to channel condition of own link and cross links of the each user station.

According to a fourth aspect of the present invention, there is provided an apparatus for beamforming training at a user station. The apparatus can comprise: training sequence receiving means configured for receiving training sequences from a service and control point by using a fixed receive antenna weight vector; and channel information determination means configured for determining channel information related to channel condition of own link and cross links of the user station; and channel information transmission means configured for transmitting the channel information to the service and control point.

According to a fifth aspect of the present invention, there is provided a system of beamforming training for a wireless communication system. The system may comprise an apparatus for beamforming training at a service and control point according to the third aspect of the present invention and an apparatus for beamforming training at a user station according to the fourth aspect of the present invention.

According to the present invention, there is provided a spatial-reuse based simultaneous beamforming training technology, which may satisfy demands of a dense-user application. Moreover, compared with the prior solutions, it considers the signal strength of own link and cross links as well as spatial orthogonality; further, has a high spectrum efficiency and saves the time for beamforming training.

### BRIEF DESCRIPTION OF THE DRAWINGS

The above and other features of the present invention will become more apparent through detailed description of the embodiments as illustrated with reference to the accompanying drawings. In the accompanying drawings of the present invention, like reference signs indicate like or similar components. Wherein,

FIG. 1 illustrates a method for beamforming training in the prior art.

FIG. 2 illustrates an example of a wireless communication system that may apply the present invention.

FIGS. 3A and 3B illustrate a RF multi-user transmitter that supports RF spatial-reuse beamforming and the simplified physical structure of its modulator.

FIG. 4 illustrates a flow chart for beamforming training according to an embodiment of the present invention.

FIG. 5 illustrates a flow chart for beamforming training according to another embodiment of the present invention.

FIG. 6 illustrates an exemplary training sequence that may be used in the present invention.

FIG. 7 illustrates another exemplary training sequence that may be used in the present invention.

FIG. 8 illustrates a flow chart of a method for beamforming training at a service and control point according to an embodiment of the present invention.

FIG. 9 illustrates a flow chart of a method for beamforming training at a user station according to an embodiment of the present invention.

FIG. 10 illustrates a block diagram of an apparatus for beamforming training at a service and control point according to an embodiment of the present invention.

FIG. 11 illustrates a block diagram of an apparatus for beamforming training at a user station according to an embodiment of the present invention.

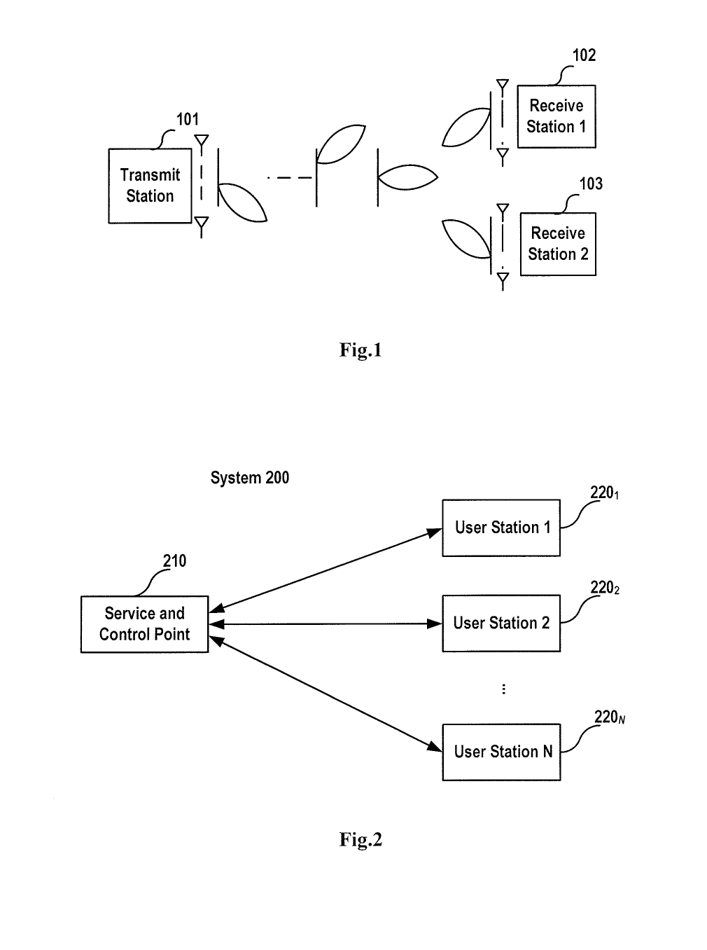

### DETAILED DESCRIPTION OF THE INVENTION

Hereinafter, beamforming training methods, apparatuses and system for a wireless communication system according to the present invention will be described in detail through preferred embodiments with reference to the drawings.

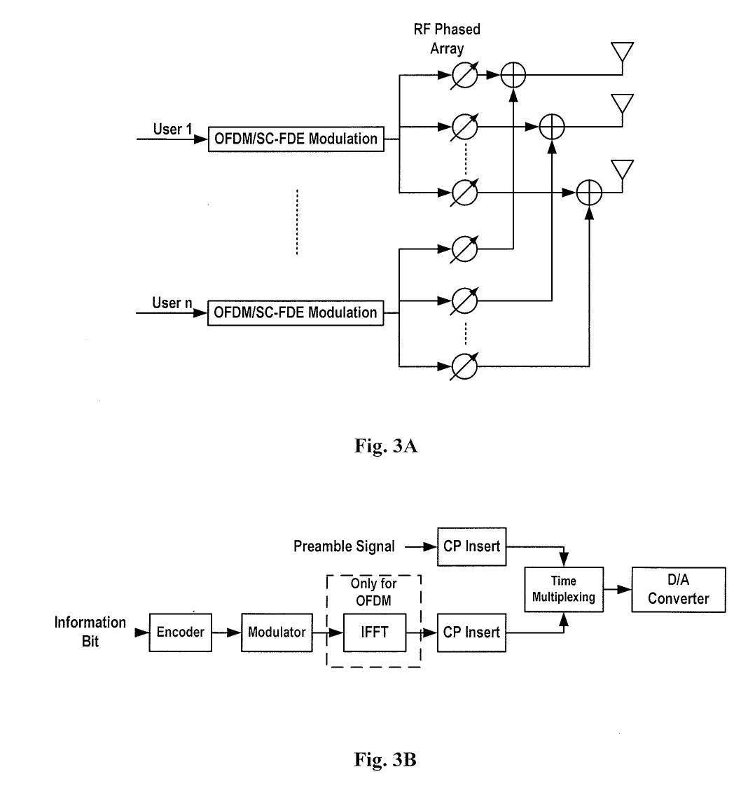

Before the method, apparatus, and system according to the present invention are described in detail, reference is first made to FIG. 2, FIG. 3A, and FIG. 3B to describe an example of a wireless communication system that may apply the present invention, a RF transmitter that supports multi-user transmission through RF spatial-reuse, and the structure of the modulator of the RF transmitter, such that those skilled in the art may understand the present invention more clearly.

As illustrated in FIG. 2, the wireless communication system 200 comprises a service and control point 210 and multiple user stations 220₁, 220₂, . . . , and 220_{N}, wherein n indicates the number of user stations. In one embodiment, user stations 220₁, 220₂, . . . , 220_{N} may form a basic service set BSS/personal basic service set PBSS. In this case, the service and control point 210 configured to provide service, coordination, and control to the user stations may be an access point AP in the BSS or the control and coordination point PCP in the PBSS.

The service and control point 210 comprises a transmit antenna array for transmitting wireless signals, wherein the transmit antenna array may comprise a plurality of antenna units. Additionally, it is assumed that the transmit antenna array of the service and control point 210 comprises t antenna units, wherein t is an integer greater than 1.

Correspondingly, each of the user stations 220₁, 220₂, . . . , and 220_{N} comprises a receive antenna array for receiving wireless signals, wherein the receive antenna array likewise may comprise a plurality of antenna units. Additionally, it is supposed that the receive antenna array of the user station 220ᵢ (i=1, 2, . . . , N, wherein N is the number of user stations) comprises rᵢ antenna units, wherein rᵢ is an integer greater than 1.

In order to perform beamforming, at the service and control point 210, phase shifting is applied to each antenna unit in the transmit antenna array, and it is also possible to apply amplitude scaling; correspondingly, at the user stations, phase shifting is applied to each antenna unit in the receive antenna array, and it is further possible to apply amplitude scaling.

Antenna weigh vector AWV may also be called as beamforming vector which describes phase shifting (and possibly amplitude scaling) applied to each antenna unit in an antenna array when beamforming. For the sake of description, hereinafter, the antenna weight vector of the transmit antenna array of the service and control point 210 is referred to shortly as TX AWV, and the antenna weight vector of the receive antenna array of the user station 220 may also be referred to shortly as RX AWV.

At the service and control point 210, a plurality of different transmit antenna weight vectors may be used. These antenna weight vectors which can be used by the service and control point 210 may form a matrix, wherein each column (or each row) in the matrix denotes an antenna weight vector. This matrix is called as a transmit codebook, or shortly as TX codebook. In one embodiment, the TX codebook of the service and control point 210 is a square matrix; in other words, the number of available TX AWVs is equivalent to the number of transmit antenna units included in the transmit antenna array of the service and control point. In one embodiment, the TX codebook may adopt the form of unitary matrix, where the number of columns of the matrix is equal to the number of antenna units included in the transmit antenna array of the service and control point. For example, for the service and control point 210 including t antenna units in the transmit antenna array, its TX codebook W may be a discrete Fourier matrix as illustrated in the following Equation 1:

$$\begin{matrix}W = \frac{1}{\sqrt{t}} [ \begin{matrix}{w}^{0} & {w}_{i}^{1} & ⋮ & {w}^{t - 1} \\ {w}^{0} & {w}_{i}^{2} & ⋮ & {w}^{2 ( t - 1 )} \\ ⋮ & ⋮ & ⋮ & ⋮ \\ {w}^{0} & {w}^{n} & ⋮ & {w}^{t ( t - 1 )}\end{matrix} ] \\ = [ {\begin{matrix}{w}_{1} & {w}_{2} & … & {w}_{k} & … & w\end{matrix}}_{t} ]\end{matrix} \qquad ( Equation 1 )$$

wherein, w=e^{-j2π/t}, and j=\sqrt{−1}. The kth column wk of W indicates the kth ransmit antenna weight vector, wherein k=1, 2, . . . , t.

Those skilled in the art should be clear that the TX codebook is not limited to the above example, but may adopt any other suitable form. Additionally, it should be further noted that in this text, [.]^{T} denotes transpose of a vector or matrix, and [.]^{H} denotes Hermitan conjugation of a vector or matrix.

Similarly, at the user station, it can also use a plurality of different receive antenna weight vectors. These antenna weight vectors available for each user station also form a matrix, wherein each column (or each row) in the matrix denotes an antenna weight vector. This matrix is called a receive codebook, or shortly as RX codebook. In one embodiment, the RX codebook of the user station is a square matrix, that is to say, the number of RX AWV of the user station is equal to the number of receive antenna units included in the receive antenna array of the user station. In one embodiment, the RX codebook may adopt the form of unitary matrix, wherein the number of columns of the matrix is equal to the number of antenna units included in the transmit antenna array of the corresponding user station. For example, for the user station 220ᵢ (wherein i=1, 2, . . . , N) including rᵢ antenna units in the receive antenna array, its RX codebook Dᵢ may be a discrete Fourier matrix as illustrated in the following equation 2:

$$\begin{matrix}{D}_{i} = \frac{1}{\sqrt{{r}_{i}}} [ \begin{matrix}{d}_{i}^{0} & {d}_{i}^{1} & ⋮ & {d}_{i}^{{r}_{j} - 1} \\ {d}_{i}^{0} & {d}_{i}^{2} & ⋮ & {d}_{i}^{2 ( {r}_{i} - 1 )} \\ ⋮ & ⋮ & ⋮ & ⋮ \\ {d}_{i}^{0} & {d}_{i}^{{r}_{i}} & ⋮ & {d}_{i}^{{r}_{i} ( {r}_{i} - 1 )}\end{matrix} ] \\ = [ \begin{matrix}{d}_{i , 1} & {d}_{i , 2} & … & {d}_{i , k} & … & {d}_{i , {r}_{i}}\end{matrix} ]\end{matrix} \qquad ( Equation 2 )$$

wherein, dᵢ=e^{-j2π/r}^{ᵢ}, and j=\sqrt{−1}. The kth column d_{i,k} of Di denotes the kth receive antenna weight vector of the user station 220i, wherein k=1, 2, . . . , ri. Those skilled in the art should be clear that the RX codebook is not limited to the above example, but may adopt any other suitable form.

The above illustrated wireless communication system 100 may be, for example, a sync and go system, which may provide fast access applications to user stations at public places such as airport, station, and etc., and provide content service such as films, clips to the user stations, and the service and control point may be a content server. Additionally, the wireless communication system may be a WLAN-based wireless communication system, or any other suitable one-to-many wireless communication system.

Next referring to FIG. 3A, it illustrates a simplified physical structure of a RF multi-user transmitter that supports RF spatial-reuse beamforming. As illustrated in FIG. 3A, before the user stream for each user station is fed to a RF phased array of the transmitter, an OFDM/SC-FDE (orthogonal frequency division multiplexing-single carrier frequency domain equalization) modulation is performed on the user stream. After being modulated, it is sent to the RF phased array to perform phase shifting. Then, respective user streams subjected to the phase shifting are added and sent out through an antenna array. Different from the digital multi-user transmitter that performs the OFDM/SC-FDE modulation after performing the phase shifting on the user streams and adding, RF multi-user transmitter performs the OFDM/SC-FDE modulation before performing the phase shifting. Thus, the RF multi-user beamforming only needs RF chains whose number is identical to the number of users, while the digital multi-user beamforming needs RF chains whose number is identical to the number of transmit antennas. It is known that the supported user number is generally far less than the number of phase shifting antenna units. Thus, in comparison, the implementation cost and complexity degree of the RF beamforming is significantly reduced.

Further, FIG. 3B schematically illustrates a diagram of an internal structure of an OFDM/SC-FDE modulation module. As illustrated in the figure, the modulation module comprises an encoder, a modulator, an IFFT (Inverse Fast Fourier transform) block (only required in the case of OFDM), a CP insertion block for information bits, a CP insertion block for preamble signals, a time-reuse block, and a D/A converter. Its structure and specific operations are known in the art, which will not be detailed herein.

As illustrated in FIG. 3A, all user streams are added together before being sent through the antenna array, thus in the wireless communication system 200, when the service control point 210 performs wireless communication simultaneously with multiple user stations, each user station may not only receive the wireless signals transmitted thereto from the service and control point 210, but also receive the wireless signals transmitted from the service and control point 210 to other user stations.

Thus, in order to enable the user station 220ᵢ to receive the signal for itself (the signal on the own link) transmitted from the service and control point 210 with a quality as high as possible and to minimize the interference from the cross links, beamforming training may be performed to the transmit antenna array of the service and control point 210 and the receive antenna array of the user station 220ᵢ, so as to determine at least one of optimum TX AWV and optimum RX AWV.

According to the present invention, there is provided a spatial-reuse based simultaneous beamforming training method. The service and control point 210 may transmit training sequences to the user stations in a predetermined training time slot that comprises a plurality of sub time slots; the user stations 220₁, 220₂, . . . , and 220_{N} receive the training sequences via their respective antenna arrays and obtain the channel information related to channel conditions of respective links (including the own link and cross links) between the service and control point 210 and each of the user station. This information may be used to determine at least one of the optimum TX AWVs of the transmit antenna array of the service and control point 210 and the optimum RX AWVs of the receive antenna array of user stations 220₁, 220₂, . . . , and 220_{N}. In this regard, detailed description will be made in detail hereinafter.

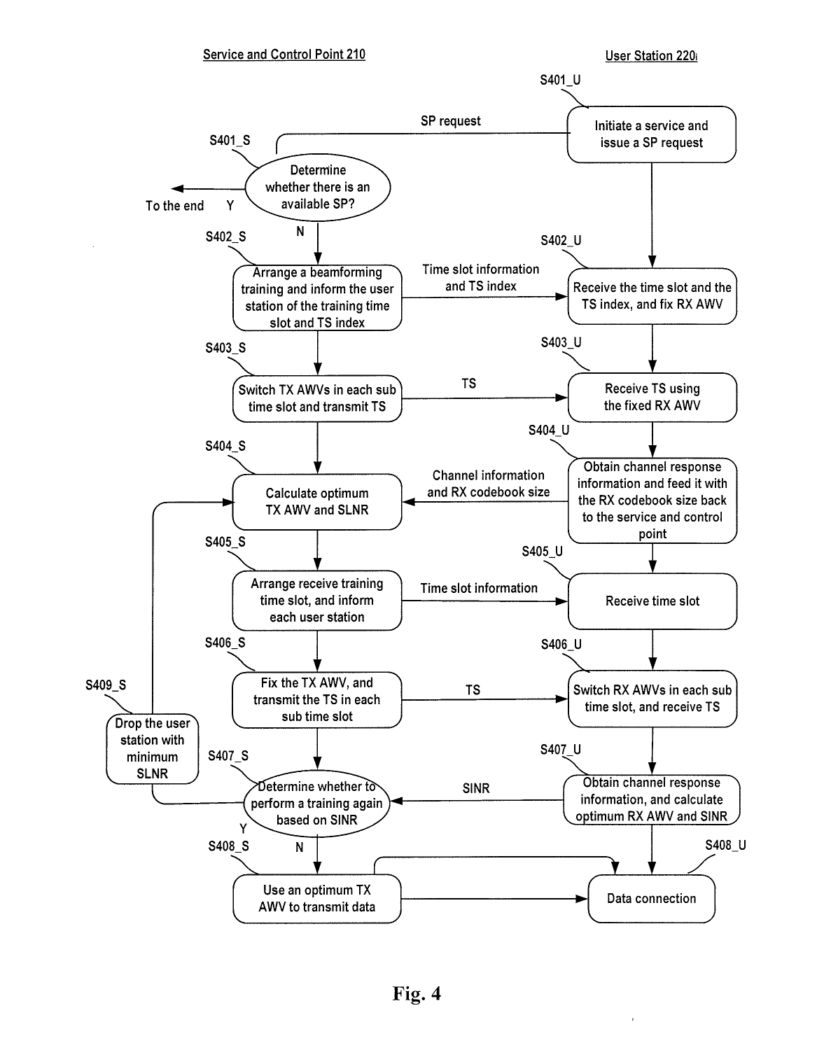

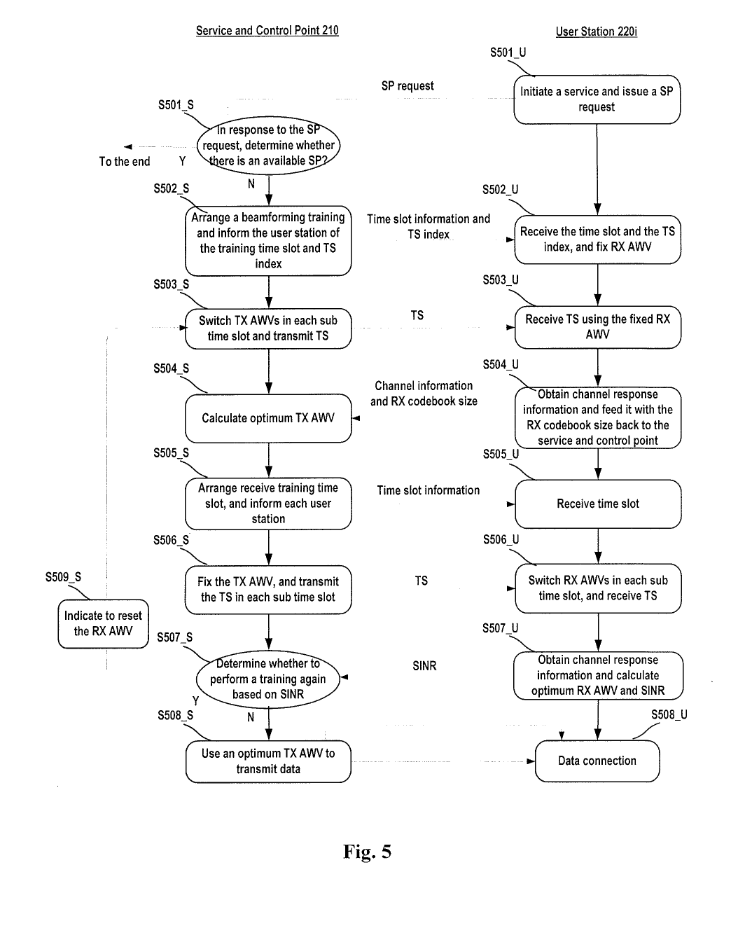

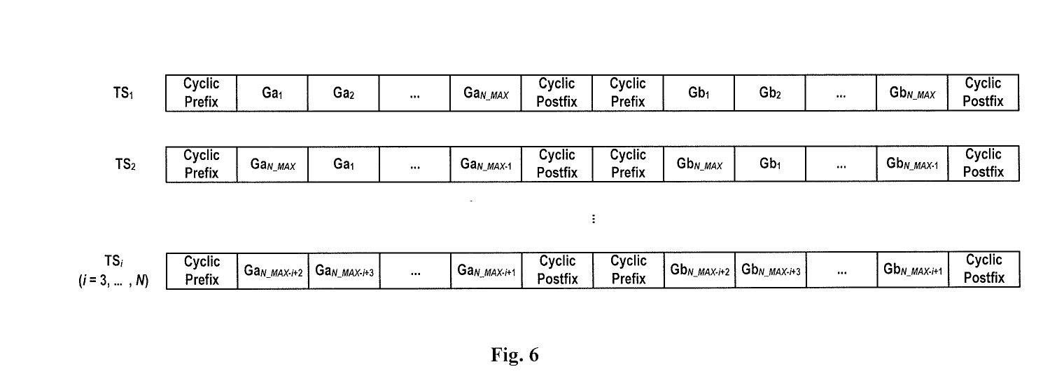

In the following, FIG. 4 and FIG. 5 will be referenced to describe a beamforming training solution according to the present invention by combining operations at the service and control point with operations at the user station, such that those skilled in the art has an overall understanding on the solution of the present invention.

First, reference is made to FIG. 4, which illustrates a flow chart of beamforming training according to an embodiment of the present invention. As illustrated in FIG. 4, the user station 220ᵢ first issues at S401_U a service period (SP) request to the service and control point 210. The service and control point 210 checks availability of the SP at step S401_S in response to the request. When no suitable SP is available, it is determined to adopt a spatial-reuse based simultaneous beamforming training and the method enters into step S402_S; otherwise, if there is available SP, this method is terminated.

In a case that it is determined to perform spatial-reuse based simultaneous beamforming training, the flow enters into the training initialization phase, where the service and control point 210 arranges at step S402_S training time slot and training sequences TS for the beamforming training.

Once the time slot and training sequences are arranged, the service and control point 210 informs the time slot information and the TS index to the user station 220ᵢ as illustrated in the figure. In one embodiment, an arranged transmit training time slot comprises T transmit training sub time slots, where T denotes the maximum column number of the TX codebook of the service and control point 210.

Once the user station 220ᵢ knows the TS index assigned thereto, it may derive the training sequence assigned thereto. In this way, because the training sequence is known to both the service and control point 210 and the user station 220ᵢ, each station may estimate, when receiving the training sequence, a channel response between itself and the service and control point 210. In addition, in the present invention, the training sequences for respective user stations are orthogonal, and thus, when receiving a training sequence, each user station may distinguish whether the training sequence is sent to itself or to another user station.

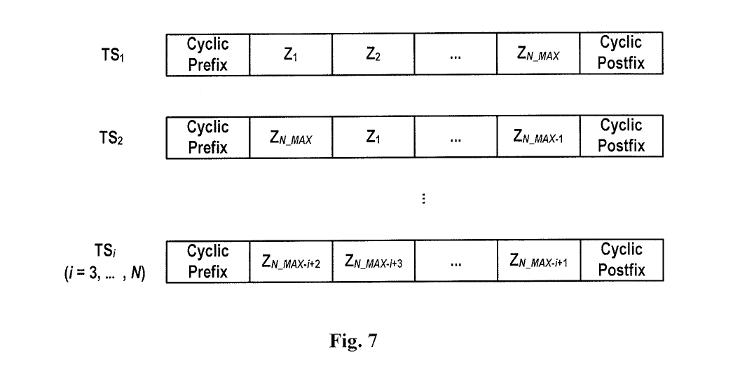

Here, for the sake of convenience, the training sequence that is assigned to the user station 220ᵢ is denoted by TSᵢ. Regarding the orthogonal training sequences, detailed description will made hereinafter with reference to FIG. 6 and FIG. 7.

After receiving the time slot information and the training sequences, the user stations 220ᵢ fix the antenna weight vectors of their own receive antenna arrays to a certain RX AWV. Among respective user stations, this fixed RX AWV may be identical or different. Further, this RX AWV may be the most commonly used one or selected according to other selection standard. For example, the user station 220ᵢ may fix its own receive antenna weight vector as a certain column in the RX codebook Dᵢ as previously illustrated.

Next, the flow proceeds to the training phase. At step S403_S, the service and control point 210 transmits the training sequences by using switched TX AWVs. In particular, in each assigned transmit training sub time slot, the service and control point 210 takes a different column of TX AWV from its TX codebook and applies the taken TX AWV to the transmit antenna array so as to tune the phase (and amplitude) of each antenna unit. Afterwards, the training sequence is transmitted through the transmit antenna array to the user station 220ᵢ.

For example, the service and control point 210 applies the kth TX AWV (for example, the kth column in Wᵢ) to its transmit antenna array in the kth (k=1, 2, . . . , t) transmit training sub time slot and transmits the training sequence TS through each antenna unit of its transmit antenna array.

At step S403_U, respective user stations 220ᵢ receive the training sequences from the service and control point 210 in the case that respective user stations 220ᵢ fix their respective RX AWVs. Herein, the user station 220ᵢ will also receive the training sequences that are transmitted to other user stations in the system (namely, signals over the cross links), besides the training sequence transmitted to itself (namely, the signal over its own link).

In the entire transmit training time slot comprising T transmit training sub sequences, the training sequences for the user station 220ᵢ and other user stations 220_{q} as received by the user station 220ᵢ through its receive antenna array form a matrix TR_{i,q} (i=1, 2, . . . , N, q=1, 2, . . . , N) listed as below:

$$\begin{matrix}{TR}_{i , q} = ⌊ \begin{matrix}{tr}_{i , q , 1} & {tr}_{i , q , 2} & … & {tr}_{i , q , k} & … & {tr}_{i , q , t }\end{matrix} ⌋ \\ = [ \begin{matrix}{tr}_{i , q , 1 , 1} & {tr}_{i , q , 2 , 1} & … & {tr}_{i , q , k , 1} & … & {tr}_{i , q , t , 1} \\ {tr}_{i , q , 1 , 2} & {tr}_{i , q , 2 , 2} & … & {tr}_{i , q , k , 2} & … & {tr}_{i , q , t , 2} \\ ⋮ & ⋮ & ⋮ & ⋮ & ⋮ & ⋮ \\ {tr}_{i , q , 1 , s} & {tr}_{i , q , 2 , s} & … & {tr}_{i , q , k , s} & … & {tr}_{i , q , t , s} \\ ⋮ & ⋮ & ⋮ & ⋮ & ⋮ & ⋮ \\ {tr}_{i , q , 1 , M} & {tr}_{i , q , 2 , M} & … & {tr}_{i , q , k , M} & … & {tr}_{i , q , t , M}\end{matrix} ]\end{matrix} \qquad ( Equation 3 )$$

wherein k denotes a sub time slot index, k=1, 2, . . . , t; s denotes a symbol index, and s=1, 2, . . . , M. Therefore, it may be understood that TR_{i,q} (i=q) denotes a received training sequence for the own link, while TR_{i,q} (i≠q) denotes a received training sequence for a cross link.

At step S403_U, respective user stations 220ᵢ further obtain/estimate, for their own links and cross links, channel information related to channel conditions of respective links (their own links and cross links), and inform the obtained channel information and sizes (for example, column numbers) of respective RX codebooks to the service and control point 210. The channel information may comprise any one of a channel impulse response (CIR), an average frequency domain channel response (CR) on all subcarriers, a CR covariance matrix on all subcarriers.

Specifically, if x_{i,q,s}^{T} is used to denote one row in the training sequence matrix, x_{i,q,s}^{T} may be called as a particular transmit weighted channel impulse response CIR as a kind of channel information measured by the user station 220i, which may be expressed below:

x_{i,q,s}^{T}=dᵢ^{T}hₛW (Equation 4)

wherein, dᵢ denotes a fixed RX AWV used by the user station 220ᵢ during the transmit training time slot, hₛ denotes a multi-input multi-output (MIMO) CIR during the sth symbol instant, and W denotes the TX codebook of the service and control point 210.

The user station may further convert the CIR to a frequency domain so as to obtain the frequency domain channel response CRᵢ for the cth subcarrier.

X_{i,q,c}^{T}dᵢ^{T}H_{c}W_{q} (Equation 5)

wherein c denotes an index of subcarriers, c=1, 2, . . . , C, and C is the total number of subcarriers.

Further, the average frequency domain channel response for all subcarriers (C subcarriers) may be obtained based on the above equation:

$$E ( {X}_{i , q , c}^{T} ) = \frac{1}{C} {\sum }_{c} {X}_{i , q , , c}^{T} \qquad ( Equation 6 )$$

Moreover, the CR covariance matrix may be further obtained through the following equation:

$$E ( {X}_{i , q , c}^{*} {X}_{i , q , c}^{T} ) = \frac{1}{C} {\sum }_{c} {X}_{i , q , c}^{*} {X}_{i , q , c}^{T} \qquad ( Equation 7 )$$

Each user station 220ᵢ takes the specific transmit weight channel impulse response, frequency domain channel response, average frequency domain channel response, or channel response covariance matrix as channel information and feeds it back together with the size (column number) rᵢ of RX codebook to the service and control point 210, wherein i=1, 2, . . . , N. It should be noted that if the service and control point 210 has known the RX codebook of respective user stations in the system through a certain manner in advance, then the user stations here do not need informing the size of RX codebook to the service and control point 210. Further, in one embodiment, channel information may be further quantized to reduce overheads.

After receiving the channel information and RX codebook size as fed back from respective user stations 220ᵢ, at step S404_S, the service and control point 210 calculates optimum TX AWVs and SINRs as the metric for link leakage condition for the user stations 220ᵢ.

Specifically, the optimum TX AWV for the user stream i corresponding to a user station 220ᵢ may be calculated by the following equation:

$${w}_{i}^{′} = eig \{ {( ( {\sum }_{1 \leq q \leq N , q \neq i} {R}_{i , q} ) + {N}_{0} I )}^{- 1} {R}_{i , i} \} \qquad ( Equation 8 )$$

wherein, q denotes the index for all cross links related to the user streamᵢ, eig(.) denotes the maximum eigenvector, N₀ denotes the single sided power spectral density (PSD) of additive white Gaussian noise (AWGN).

If the CIR is fed back from the user station 220ᵢ, then the service and control point 201 may first utilize the above equation 6 or 7 to calculate the average frequency domain channel response or CR covariance matrix, and then further calculate the R_{i,q} as stated in the above equation using the following equation 9 or 10. If the average channel response or CR covariance matrix is fed back from the user station, the service and control point 210 may directly use the following equation 9 or equation 10 to calculate the R_{i,q} as stated in the above equation.

R_{i,q}=WE(X_{i,q}*)E(X_{i,q}^{T})W^{H} (Equation 9)

R_{i,q}=WE(X_{i,q}*X_{i,q}^{T})W^{H} (Equation 10)

Preferably, the service and control point 210 may calculate the transmitter SINRᵢ of the user stream i corresponding to the user station 220ᵢ through the following equation:

$${SLNR}_{i} = \frac{{w}_{i}^{′ H} {R}_{i , i} {w}_{i}^{′}}{{\sum }_{1 \leq q \leq N , q \neq i} {w}_{i}^{′ H} {R}_{i , q} {w}_{i}^{′} + {N}_{0} I} \qquad ( Equation 11 )$$

The SLNR is a criterion for measuring the orthogonality of respective links. The larger the value is, the greater is the strength of own signal and the less is the signal interference on other links. The SLNR may be used in the training pre-processing operation to be described hereinafter.

Preferably, after performing the transmit training, the receive training may also be performed. In an embodiment wherein the receive training is further performed, the service and control point 210 arranges a receive training time slot at step S405_S and informs it to respective user stations. Correspondingly, the user station receives the time slot information at S405_U.

Then, at step S406_S, the service and control point 210 fixes its TX AWV, and preferably, fixes it as the previously determined optimum TX AWV, namely, w′ₖ. Moreover, the service and control point 210, during the arranged training time slot including RN receive training sub time slots, applies w′ₖ to its transmit antenna array and transmits the training sequence TS via each antenna unit of its transmit antenna array.

Then, at step S406_U, the user station 220ᵢ switches its RX AWVs during the respective receiving training sub time slots and receives the training sequence transmitted from the service and control point 210.

For example, the user station 220ᵢ applies the kth RX AWV (for example, the kth column in Dᵢ) to its receive antenna array during the kth (k=1, 2, . . . , rᵢ) receive training sub time slot and receives via its receive antenna array the training sequence transmitted from the service and control point 210.

Here, besides the training sequence transmitted by the service and control point 210 to the user station 220ᵢ itself (namely, the signals over the own links), the user station will also receive the training sequences transmitted from the service and control point 210 to other user stations 220_{q} (i≠q) (namely, signals over the cross links).

Supposing that, in the entire receive training time slot, the training sequences as received by the user station 220ᵢ for its own through its receive antenna array and the training sequences to other user stations form a matrix RR_{i,q} (i=1, 2, . . . , N, q=1, 2, . . . , N) as below:

$${RR}_{i , q} = [ \begin{matrix}{rr}_{i , q , 1}^{T} \\ {rr}_{i , q , 2}^{T} \\ ⋮ \\ {rr}_{i , q , k}^{T} \\ ⋮ \\ {rr}_{i , q , {r}_{i}}^{T}\end{matrix} ] = [ \begin{matrix}{rr}_{i , q , 1 , 1} & {rr}_{i , q , 1 , 2} & … & {rr}_{i , q , 1 , s} & … & {rr}_{i , q , 1 , M} \\ {rr}_{i , q , 2 , 1} & {rr}_{i , q , 2 , 2} & … & {rr}_{i , q , 2 , s} & … & {rr}_{i , q , 2 , M} \\ ⋮ & ⋮ & ⋮ & ⋮ & ⋮ & ⋮ \\ {rr}_{i , q , k , 1} & {rr}_{i , q , k , 2} & … & {rr}_{i , q , k , s} & … & {rr}_{i , q , k , M} \\ ⋮ & ⋮ & ⋮ & ⋮ & ⋮ & ⋮ \\ {rr}_{i , q , {r}_{i} , 1} & {rr}_{i , q , {r}_{i} , 2} & … & {rr}_{i , q , {r}_{i} , s} & … & {rr}_{i , q , {r}_{i} , M}\end{matrix} ] \qquad ( Equation 12 )$$

wherein s denotes a symbol index, and s=1, 2, . . . , M; k denotes a sub time slot index, and k=1, 2, . . . , rᵢ. Therefore, it may be understood that TR_{i,q} (i=q) denotes a received training sequence for the own link, while TR_{i,q} (i≠q) denotes a received training sequence for a cross link.

At step S407_U, the user station 220ᵢ obtains/estimates, for its own link and cross links, channel information related to the channel condition of respective links (own link and cross links). The channel information may comprise any one of a channel impulse response, an average frequency domain channel response on all sub-carriers, a channel covariance matrix on all subcarriers.

If y_{i,q,s} denotes one column of the above training sequence matrix, then y_{i,q,s} may be called as a specific receive weighted channel impulse response CIR, which is a kind of channel information measured by the user station 220ᵢ and may be expressed as below:

y_{i,q,s}=Dᵢ^{T}hₛw′ (Equation 13)

wherein Dᵢ is a RX codebook for user station 220ᵢ, hₛ denotes a multi-input and multi-output (MIMO) CIR of the sth symbol time, and w′ is a fixed TX AWV of the service and control point during the receive training phase.

Each user station 220ᵢ further obtains (estimates), for its own link and cross links, the average frequency domain channel response and channel response covariant matrix on all subcarriers. Further, the optimum RX AWV is calculated. Preferably, SINR as the metric of link qualities of respective links may be further calculated, and then the calculated SINR is fed back to the service and control point 210.

Specifically, the channel impulse response (CIR) of the link between the user station 220ᵢ and the service and control point 210 for the sth symbol is the above mentioned y_{i,q,s}.

The CIR may be converted into the frequency domain channel response Y_{i,q,c} for the cth subcarrier, which may be expressed as:

Y_{i,q,c}=Dᵢ^{T}H_{c}w′_{q} (Equation 14)

wherein c denotes an index of subcarriers, c=1, 2, . . . , C, and C is the total number of subcarriers.

The average frequency domain channel response may be further obtained through the following equation:

$$E ( {Y}_{i , q , c} ) = \frac{1}{C} {\sum }_{c} {Y}_{i , q , c} \qquad ( Equation 15 )$$

The channel response covariance matrix may be obtained through the following equation:

$$E ( {Y}_{i , q , c} {Y}_{i , q , c}^{H} ) = \frac{1}{C} {\sum }_{c} {Y}_{i , q , c} {Y}_{i , q , c}^{H} \qquad ( Equation 16 )$$

Based on the above channel information, the user station 220ᵢ may further obtain its optimum RX AWV for communicating between itself and the service and control point 210 through the following equation:

$${d}_{i}^{′} = eig \{ {( ( {\sum }_{1 \leq q \leq N , q \neq i} {\overline{R}}_{i , q} ) + {N}_{0} I )}^{- 1} {\overline{R}}_{i , i} \} \qquad ( Equation 17 )$$

wherein eig (.) denotes the maximum eigenvector, and N₀ denotes the single sided power spectral density (PSD) of additive white Gaussian noise (AWGN).

Dependent on whether the use station 220ᵢ calculates the average frequency domain response or the channel response covariance matrix, the R̅_{i,q} as stated in the above equation may be calculated below:

R̅_{i,q}=Dᵢ*E(Y_{i.q})E(Y_{i,q}^{H})Dᵢ^{T} (Equation 18)

R̅_{i,q}=Dᵢ*E(Y_{i,q}Y_{i,q}^{H})Dᵢ^{T} (Equation 19)

Then, the user station 220ᵢ calculates the receive SINRᵢ for the ith user stream through the following equation:

$${SINR}_{i} = \frac{{d}_{i}^{′ T} {\overline{R}}_{i , i} {d}_{i}^{′ *}}{{\sum }_{1 \leq q \leq n , q \neq i} {d}_{i}^{′ T} {\overline{R}}_{i , q} {d}_{i}^{′ *} + {N}_{0} I} \qquad ( Equation 20 )$$

SINRᵢ may be used as a metric for the quality of the link between the service and control point 210 and the user station 220ᵢ. The user station 220ᵢ may then feed back the calculated SINRᵢ to the service and control point 210 for future use.

The service and control point 210 may evaluate link quality of respective links at step S407_S by comparing the SINR fed back from each user station 220ᵢ and a corresponding predetermined threshold γ, so as to determine, based on the evaluation result of the link quality, whether it is feasible to terminate beamforming training and execute spatial-reuse, or whether it is required to perform re-training.

Specifically, if the service and control point 210 finds at step S407_S that all SINRs are greater than or equal to their corresponding thresholds γ, then the service and control point 210 determines that it is feasible for perform spatial-reuse; and the method then proceeds to step S408_S. The service and control point 210 may inform an available spatial-reuse service period to each user station 220ᵢ. Afterwards, the service and control point 210 and the user station 220ᵢ may use the w′ᵢ and d′ᵢ obtained during the beamforming training process as TX AWV and RX AWV respectively to perform data communication therebetween.

On the contrary, if there is any SINR less than its corresponding threshold γ, then the service and control point 210 determines that it is required to perform spatial-reuse based beamforming training again. Then, the method proceeds to step S409_S. At step S409_S, the service and control point 210 drops one or more user stations based on the leakage condition of respective links between the service and control point 210 and respective user stations 220ᵢ. For example, the service and control point 210 may discard the user station with minimum SINR. Then, the process returns to step S404_S, if a communication pair with minimum SINR is ruled out, operations at step S404_S and subsequent steps are repeated for the remaining N−1 user stations, so as to perform a re-training, till a positive result is obtained at step S407_S.

Additionally, FIG. 5 further exemplarily illustrates a flow chart of beamforming training according to another embodiment of the present invention.

The method according to this embodiment comprises substantial identical steps as the method as illustrated in FIG. 4, except that, in FIG. 5, steps S504_S and S509_S replace steps S404_S and S409_S shown in FIG. 4. Specifically, in the method as illustrated in FIG. 5, it is not needed to calculate the SLNRs for respective links at step S504_S. Additionally, when the service and control point 210 determines that it is needed to perform a re-training, the method then proceeds to step S509_S. In this step, the service and control point 210 informs each user station 220ᵢ to fix its RX AWV to the optimum RX AWV as calculated at step S507_S, i.e., informing the user station to fix its RX AWV as d′ᵢ. Next, the process returns to step S503_S to repeat of the subsequent transmit training and the receive training with the RX AWV of each user station being reset as optimum RX AWV.

However, it should be noted that the methods as illustrated in FIG. 4 and FIG. 5 may be further combined. Namely, at step S509_S, one or more user stations may be first ruled out based on the standard based on leakage condition of respective links between the service and control point 210 and respective user stations 220ᵢ. Then, each of the remaining user stations is informed to fix its RX AWV to the optimum RX AWV as calculated at step S507_U. Afterwards, the process returns step S503_S to repeat the subsequent transmit training and receive training.

It should be noted that in the above embodiments, the depiction is mainly made with one user station 220ᵢ as an example. However, those skilled in the art would understand that other user station also performs similar operations.

Additionally, according to the present invention, when the service and control point 210 determines that there is no available service period, it may determine to perform the above beamforming training method according to the present invention. However, according to another embodiment of the present invention, the service and control point 210 may immediately perform the beamforming method according to the present invention upon receiving the SP request from a user station.

According to the present invention, the above beamforming training method according to the present invention may be performed before performing any data communication between the service and control point 210 and the user stations 220₁, 220₂, . . . , 220_{N}. However, it may also be determined to perform beamforming training according to the method of the present invention based in a case that the service and control point 210 has established data communication with some user stations thereof, in response to a service period request from another user station, while comprehensively considering the link condition in the system.

In the above embodiments depicted with reference to FIG. 4 and FIG. 5, first, the transmit training for TX AWV is performed, and then, the receive training for RX AWV is performed. However, the present invention is not limited thereto, and it is also allowed to first perform receive training and then perform transmit training, or merely perform one of transmit training and receive training.

Besides, FIG. 6 and FIG. 7 further illustrate two exemplary training sequences that may be used in the present invention.

First, an exemplary training sequence that may be used in the present invention will be described with reference to FIG. 6. As illustrated in FIG. 6, the training sequence may comprise complementary Golay sequences. A base Golay sequence G=[Ga Gb]^{T} comprises two complementary sequences Ga=[Ga₁ Ga₂ . . . Ga_{N}_{_{—}}_{MAX}]^{T} and Gb=[Gb₁ Gb₂ . . . Gb_{N}_{_{—}}_{MAX}]^{T}, wherein each of Gaᵥ and Gbᵥ (v=1, . . . , N_MAX) itself is a symbol sequence, respectively, with a length of S, i.e., comprising S symbols. N_MAX denotes the maximum number of user stations (i.e., streams) that are allowed to be trained simultaneously. When assigning an index, the service and control point 210 may assign a training sequence index i for each user station. After each user station knows the index i, the training sequence for it may be obtained. In order to enable the training sequences of a plurality of user stations (user streams) to be orthogonal therebetween, the following training sequences with the base Golay being shifted serially may be adopted:

$$User stream 1 \text{:} {TS}_{1} = {[ \begin{matrix}{Ga}_{1} & {Ga}_{2} & … & {Ga}_{N \_ MAX} & {Gb}_{1} & {Gb}_{2} & … & {Gb}_{N \_ MAX}\end{matrix} ]}^{T}$$

$$User stream 2 \text{:} {TS}_{2} = {[ \begin{matrix}{Ga}_{N \_ MAX} & {Ga}_{1} & … & {Ga}_{N \_ MAX - 1} & {Gb}_{N \_ MAX} & {Gb}_{1} & … & {Gb}_{N \_ MAX - 1}\end{matrix} ]}^{T}$$

$$…$$

$$User stream i ( i = 3 , 4 , … , N ) \text{:}$$

$${TS}_{i} = {[ \begin{matrix}{Ga}_{N \_ MAX - i + 2} & {Ga}_{N \_ MAX - i + 3} & … & {Ga}_{N \_ MAX - i + 1} & {Gb}_{N \_ MAX - i + 2} & {Gb}_{N \_ M A X - i + 3} & … & {Gb}_{N \_ MAX - i + 1}\end{matrix} ]}^{T}$$

In this way, it can cause that the training sequences for all user streams (or user stations) are orthogonal with each other.

Further, as illustrated in FIG. 6, in the training sequence for each user stream, at two ends of each sequence in two complementary sequences, a cyclic prefix and/or cyclic postfix may be attached, respectively, so as to for example, adjust any tolerable timing error caused by channels and hardwares.

It should be noted that the training sequence may be always transmitted using a single carrier mode. Additionally, the length S of Gaᵥ and Gbᵥ depends on the maximum channel order L (normalized to the chip length, i.e., the time length of each symbol comprised in Gaᵥ or Gbᵥ), by satisfying that S>=L.

Next, reference will be made to FIG. 7 to describe another exemplary training sequence that may be used in the present invention. As illustrated in FIG. 7, the training sequence may comprise a Zadoff-Chu sequence. A basic Zadoff-Chu sequence can be written as Z=[Z₁ Z₂ . . . Z_{N}_{_{—}}_{MAX}]^{T}, wherein Zᵥ(v=1, . . . , N_MAX) itself is a symbol sequence, with a length of S, i.e., comprising S symbols; N_MAX denotes the maximum number of the user streams (user stations) that are allowed to be simultaneously trained in the system. When assigning an index, it is supposed the service and control point 210 assigns a training sequence index for user stations and informs it to the user stations. Each user station, after knowing the training sequence index, may derive its associated training sequence as follows, which, for example, may be:

$$User stream 1 \text{:} {TS}_{1} = {[ {Z}_{1} {Z}_{2} … {Z}_{N \_ MAX} ]}^{T}$$

$$User stream 2 \text{:} {TS}_{2} = {[ {Z}_{N \_ MAX} {Z}_{1} … {Z}_{N \_ MAX - 1} ]}^{T}$$

$$…$$

$$User stream i ( i = 3 , 4 … , N ) \text{:}$$

$${TS}_{i} = {[ {Z}_{N \_ MAX - i + 2} {Z}_{N \_ MAX - i + 3} … {Z}_{N \_ MAX - i + 1} ]}^{T}$$

The training sequences received by all user stations are orthogonal with each other.

Further, as illustrated in FIG. 7, it is preferable to attach a cyclic prefix and/or cyclic affix to both ends of the Zadoff-Chu sequence comprised in each training sequence, respectively, so as to for example, adjust any tolerable timing error caused by channels and hardwares.

Likewise, in the case of using Zadoff-Chu sequence as a training sequence, the training sequence may also be always transmitted using a single carrier mode. Additionally, the length S of Zᵥ depends on the maximum channel order L (normalized to the chip length, i.e., the time length of each symbol comprised in Zᵥ), by satisfying that S>=L.

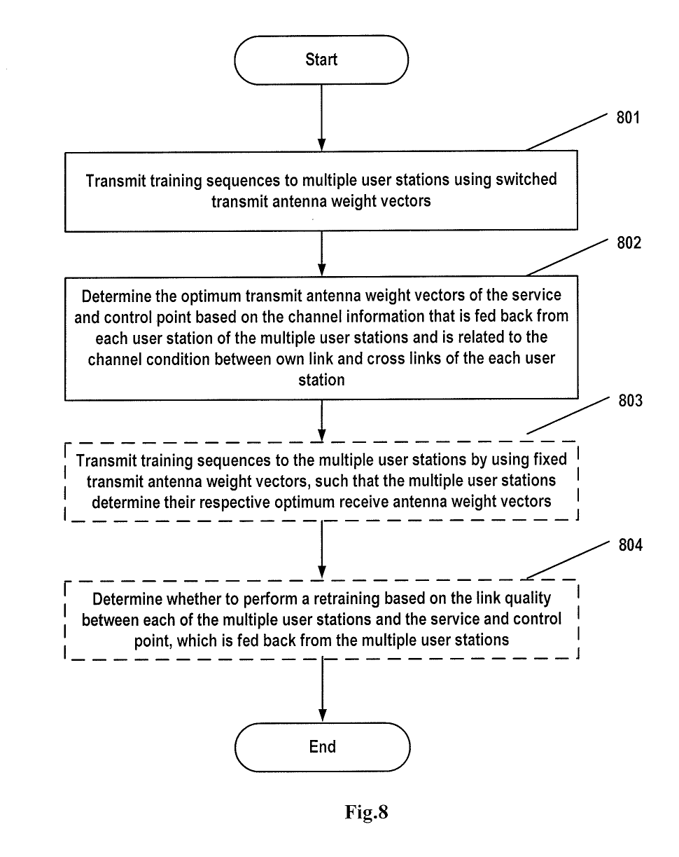

Additionally, to facilitate understanding the present invention, in the above embodiments depicted with reference to FIG. 4 and FIG. 5, the operations of the service and control point and the user stations are taken as a whole to depict the technical solution of the present invention in detail. However, the present invention is not limited thereto. The present invention further seeks to patent technical solutions for the service and control point and the user station, respectively. Hereinafter, FIGS. 8-11 will be referenced to depict, through embodiments, a method for beamforming training at a service and control point, a method for beaming training at a user station, an apparatus for beamforming training at a service and control point, an apparatus for beamforming training at a user station, and a system for beamforming for a wireless communication system according to the present invention, respectively.

First, referring to FIG. 8, FIG. 8 illustrates a method for beamforming training at a service and control point according to an embodiment of the present invention.

As illustrated in FIG. 8, first, at step 801, training sequences are transmitted to a plurality of user stations using switched transmit antenna weight vectors.

As previously mentioned, when receiving an SP request, the service and control point 210 determines whether it is needed to perform a spatial-reuse based beamforming training based on the availability of service period. When it is determined that it is needed to perform beamforming training, it assigns a training time slot and a training sequence indices to user stations. After performing the training initialization operation, the flow enters into the training phase. During respective sub time slots of the training time slot, the service and control point 210 applies the switched TX AWVs to respective antenna units and transmits it through respective antenna units.

Next, at step 802, optimum transmit antenna weight vectors of the service and control point are determined based on channel information that is fed back from each user station of the multiple user stations and related to channel condition of the own link and cross links of the each user station.

As previously mentioned, after receiving the training sequences, the user station 220ᵢ obtains the channel information related to the channel condition of the own link and cross links and returns it to the service and control point 210. After receiving the channel information (such as, for example, one or more of channel impulse response, average frequency domain channel response, CR covariance matrix on all subcarriers), the service and control point 210 determines the optimum TX AWVs based on the preceding equation 8.

Additionally, in a preferred embodiment, link leakage condition may be further determined, for example, the SINR for each link may be determined based on equations 9-11, for use in subsequent steps.

Further, preferably, the receive training for RX AWVs may be further performed. Thus, at step 803, the training sequences may be transmitted to a plurality of user stations using fixed transmit antenna weight vectors, such that the plurality of user stations determine their own optimum receive antenna weight vectors. Wherein, the transmit antenna weight vectors are preferably fixed to be the previously determined optimum TX AWVs.

Additionally, after performing the previously transmit training and receive training, it may be further determined at step 804 whether to perform a retraining based on channel quality between the each user station and the service and control point as fed back from each user station among the plurality of user stations.

When it is determined to perform the retraining, the retraining may be performed based on one of the optimum receive antenna weight vectors and the optimum transmit antenna weights. For example, in the above embodiment wherein the transmit training is performed first and then the receive training is preformed, it may be determined to merely perform the receive training, as depicted in the embodiment of FIG. 4, based on the optimum TX AWVs. Further, it may also be determined to re-perform both of the transmit training and receive training, and in this case, user stations may be first informed to fix their RX AWVs to the optimum RX AWVs, and then to perform the retraining.

Additionally, in the case of determining to perform the re-training, preferably, one or more user stations may be dropped based on the link leakage condition, so as to obtain a better training result. For example, one or more user stations that have worst link leakage condition (for example, the previously calculated SINR value) may be ruled out.

Additionally, preferably, the beamforming training may be performed in response to the determination that no suitable service period is available for the user station. In the embodiments of the present invention, the training sequences adopted are orthogonal sequences. The orthogonal training sequences, for example, may be complementary Golay sequences or Zadoff-Chu sequences, as described with reference to FIG. 6 and FIG. 7. Moreover, preferably, the training sequence may comprise at least one of cyclic prefix and cyclic postfix, for adjusting any tolerable timing error caused by channels and hardwares.

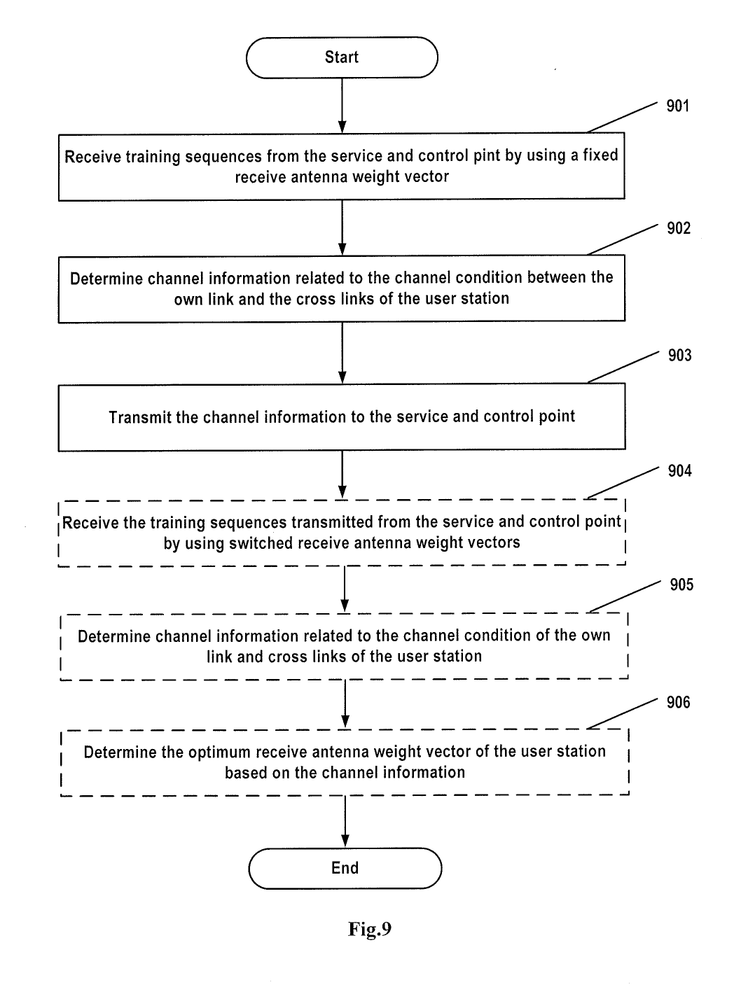

Additionally, FIG. 9 further illustrates a method for beamforming training at a user station according to an embodiment of the present invention.

As illustrated in FIG. 9, a user station first receives at step 901 training sequences from the service and control point using a fixed receive antenna weight vector. This fixed receive antenna weight vector RX AWV may be the most commonly used RX AWV or selected according to other selection standard. For example, the user station 220ᵢ may fix its own receive antenna weight vector as a certain column in Dᵢ. It should be noted that this fixed RX AWV may be identical or different between respective user stations.

After receiving the training sequences, at step 902, channel information related to channel condition of the own link and cross links of the user station may be determined. The channel information may comprise one or more of channel impulse response, average frequency domain channel response, and channel response covariance matrix on all subcarriers. The channel information for determining the optimum transmit antenna weight vector is determined based on the fixed receive antenna weight vector of the user station, multi-input multi-output channel impulse response, and the transmit codebook of the service and control point. For example, the user station may calculate the channel impact response, average frequency domain channel response, channel response covariance matrix on all sub carriers based on the previously mentioned equations 4 to 7.

Afterwards, at step 903, the user station may feed back the channel information to the service and control point, such that the service and control point determines its optimum TX AWV.

In a preferred embodiment wherein a receive training is further performed, at step 904, the training sequences transmitted from the service and control point may be further received using the switched receive antenna weight vectors. As previously mentioned, the training sequences are transmitted by the service and control point through applying a fixed TX AWV. This fixed TX AWV is preferably the optimum TX AWV.

Afterwards, the user station may determine at step 905 the channel information relating to the channel condition of the own link and cross links of the user station. The channel information may likewise comprise one or more of channel impulse response, average frequency domain channel response, and channel response covariance matrix on all subcarriers. For example, the user station may calculate the channel impulse response, average frequency domain channel response, channel response covariance matrix on all sub carriers based on the previously mentioned equations 13-16.

Then, at step 906, the optimum receive transmit weight vector of the user station may be determined based on the previously calculated channel information. The channel information for determining the optimum receive antenna weight vector is determined based on the fixed transmit antenna weight vector of the service and control point, multi-input multi-output channel impulse response, and the receive codebook of the user station. The optimum receive antenna weight vector, for example, may be determined based on the above equation 17.

Preferably, link quality between the user station and the service and control point, for example, SINR of each link, may be further evaluated based on the channel information; and the link quality may be fed back to the service and control point.

In a preferred embodiment of the present invention, the receive antenna weight vector may be reset as the optimum receive antenna weight vector in response to a receive antenna weight vector reset indication of the service and control point, so as to perform the re-training.

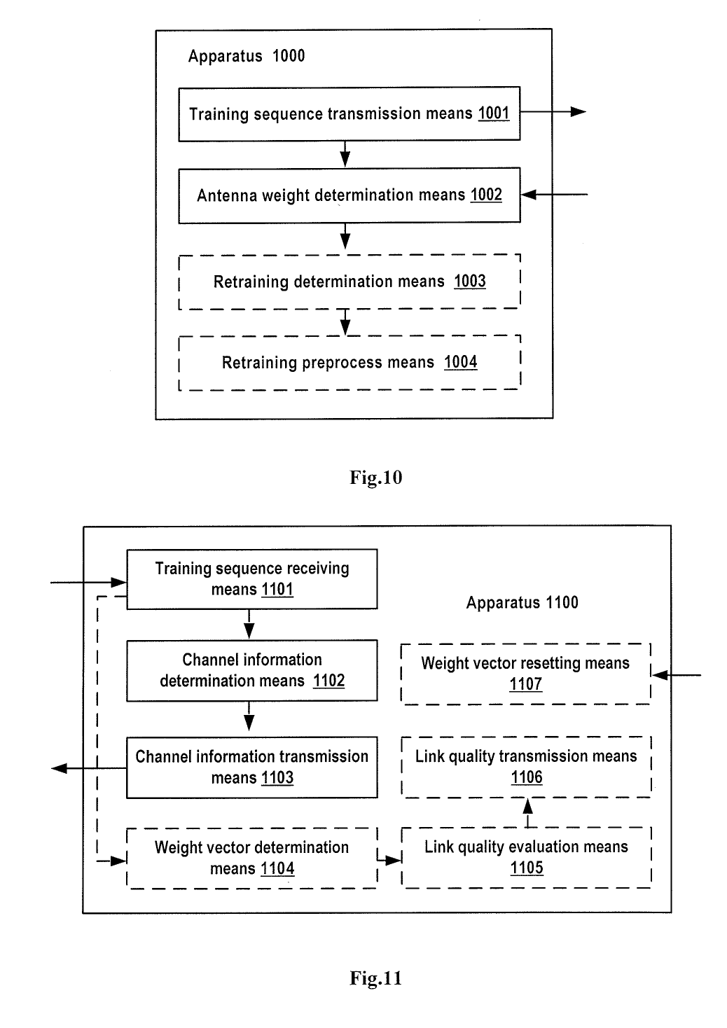

Besides, FIG. 10 further illustrates an apparatus 1000 for beamforming training at a service and control point. As illustrated in FIG. 10, the apparatus 100 may comprise: training sequence transmission means 1001 configured for transmitting training sequences to multiple user stations by using switched transmit antenna weight vectors; and antenna weight determination unit 1002 configured for determining optimum transmit antenna weight vectors of the service and control point based on channel information that is fed back from each user station of the multiple user stations and related to channel condition of own link and cross links of the each user station.

In one embodiment of the present invention, the training sequence transmission means 1001 may be further configured for transmitting training sequences to the multiple user stations by using fixed transmit antenna weight vectors such that the multiple user stations determine their own optimum receive antenna weight vectors.

In another embodiment of the present invention, the apparatus 1000 may further comprise: retraining determination means 1003 configured for determining whether to perform a retraining based on the link quality between the service and control point, which is fed back from each user station of the multiple user stations. According to an embodiment of the present invention, the retraining is performed based on one of the optimum receive antenna weight vectors and the optimum transmit antenna weights.

Besides, in the embodiments of the present invention, the apparatus 1000 may further comprise a retraining preprocess means 1004 configured for, in response to the determination of performing the retraining, dropping one or more user stations based on link leakage condition and/or indicate the user station to reset the receive antenna weight vector.

In the embodiments of the present invention, the beamforming training may be performed in response to the determination that no suitable service period is available for the user station.

According to the embodiments of the present invention, the training sequences may be orthogonal sequences, for example, complementary Golay sequences or Zadoff-Chu sequences. Preferably, each of the training sequences may comprise at least one of cyclic prefix and cyclic postfix.

Next, referring to FIG. 11, it illustrates an apparatus 1100 for beamforming training at a user station. As illustrated in FIG. 11, the apparatus 1100 may comprise: training sequence receiving means 1101 configured for receiving training sequences from a service and control point by using a fixed receive antenna weight vector; and channel information determination means 1102 configured for determining channel information related to channel condition of own link and cross links of the user station; and channel information transmission means 1103 configured to transmit the channel information to the service and control point. Wherein, the channel information for determining the optimum transmit antenna weight vector is determined based on the fixed receive antenna weight vector of the user station, the multi-input multi-output channel impulse response, and the transmit codebook of the service and control point.

The training sequence receiving means 1101 may be further configured for receiving training sequences transmitted from the service and control point using switched receive antenna weight vectors; the channel information determination means 1102 is further configured for determining channel information related to the channel condition of the own link and cross links of the user station; and the apparatus may further comprise: weight vector determination means 1104 is configured for determining the optimum receive antenna weight vector based on the channel information. The channel information for determining the optimum receive antenna weight vector is determined based on the fixed transmit antenna weight vector of the service and control point, multi-input multi-output channel impulse response, and the receive codebook of the user station.

According to the preferred embodiments of the present invention, the apparatus 1100 may further comprise: link quality evaluation means 1105, configured for evaluating link quality between the user station and the service and control point based on the channel information; and link quality transmit means 1106 configured to feed back the link quality to the service and control point.

In the preferred embodiments of the present invention, the apparatus 1100 further comprises: weight vector resetting means 1107 configured for resetting the receive antenna weight vector as the optimum receive antenna weight vector in response to the receive antenna weight vector resetting indication, so as to perform the re-training.

Besides, the present invention further discloses a system for beamforming training for a wireless communication system, which may comprise an apparatus for beamforming training at a service and control point as described with reference to FIG. 10 and an apparatus for beamforming training at a user station as described with reference to FIG. 11.

For details about the method steps and specific operations of the apparatus as described in FIGS. 8-11, please refer to the depiction with reference to FIGS. 4-7, which will not be detailed herein.

According to the present invention, there is provided a spatial-reuse based simultaneous beamforming training technology, which may satisfy the demands of a dense-user application. Moreover, compared with the prior solutions, it considers the signal strength of own link and cross links as well as spatial orthogonality; further, it has a high spectrum efficiency and saves beamforming training time.

Further, it should be noted that the embodiments of the present invention can be implemented in software, hardware or the combination thereof. The hardware part can be implemented by a special logic; the software part can be stored in a memory and executed by a proper instruction execution system such as a microprocessor or a dedicated designed hardware. Those normally skilled in the art may appreciate that the above method and system can be implemented with a computer-executable instructions and/or control codes contained in the processor, for example, such codes provided on a bearer medium such as a magnetic disk, CD, or DVD-ROM, or a programmable memory such as a read-only memory (firmware) or a data bearer such as an optical or electronic signal bearer. The apparatus and its components in the present embodiments may be implemented by hardware circuitry, for example a very large scale integrated circuit or gate array, a semiconductor such as logical chip or transistor, or a programmable hardware device such as a field-programmable gate array, or a programmable logical device, or implemented by software executed by various kinds of processors, or implemented by combination of the above hardware circuitry and software, for example by firmware.

Though the present invention has been described with reference to the currently considered embodiments, it should be appreciated that the present invention is not limited the disclosed embodiments. On the contrary, the present invention is intended to cover various modifications and equivalent arrangements falling within in the spirit and scope of the appended claims. The scope of the appended claims is accorded with broadest explanations and covers all such modifications and equivalent structures and functions.

What is claimed is:

1. A method for beamforming training at a service and control point, comprising:
transmitting training sequences to multiple user stations using switched transmit antenna weight vectors; and
determining optimum transmit antenna weight vectors of the service and control point based on channel information that is fed back from each user station of the multiple user stations and related to channel condition of own link and cross links of the each user station.

2. The method according to claim 1, further comprising:
transmitting training sequences to the multiple user stations using fixed transmit antenna weight vectors, such that the multiple user stations determine their respective optimum receive antenna weight vectors.

3. The method according to claim 2, further comprising:
determining whether to perform a retraining based on link quality between each user station of the multiple user stations and the service and control point, which is fed back from the each user station.

4. The method according to claim 3, wherein the retraining is performed based on one of the optimum receive antenna weight vectors and the optimum transmit antenna weight vectors.

5. The method according to claim 4, further comprising:
dropping one or more user stations based on link leakage condition and/or indicating the user stations to reset receive antenna weight vectors, in response to the determining to perform the retraining.

6. The method according to claim 1, wherein the training sequences are orthogonal sequences.

7. The method according to claim 6, wherein each of the training sequences comprises a complementary Golay sequence or a Zadoff-Chu sequence.

8. The method according to claim 7, wherein each of the training sequences comprises at least one of a cyclic prefix and a cyclic postfix.

9. A method for beamforming training at a user station, comprising:
receiving training sequences from a service and control point by using a fixed receive antenna weight vector;
determining channel information related to channel condition of own link and cross links of the user station; and
transmitting the channel information to the service and control point.

10. The method according to claim 9, further comprising:
receiving training sequences transmitted from the service and control point by using switched receive antenna weight vectors;
determining channel information related to channel condition of own link and cross links of the user station; and
determining an optimum receive antenna weight vector of the user station based on the channel information.

11. The method according to claim 10, further comprising:
evaluating link quality between the user station and the service and control pint based on the channel information; and
feeding back the link quality to the service and control point.

12. The method according to claim 11, further comprising:
resetting the receive antenna weight vector as the optimum receive antenna weight vector in response to a receive antenna weight vector resetting indication from the service and control point, so as to perform a retraining.

13. The method according to claim 9, wherein the channel information for determining the optimum transmit antenna weight vectors is determined based on the fixed receive antenna weight vector of the user station, a multi-input multi-output channel impulse response, and a transmit codebook of the service and control point.

14. The method according to claim 10, wherein the channel information for determining the optimum receive antenna weight vector is determined based on the fixed transmit antenna weight vector of the service and control point, a multi-input multi-output channel impulse response, and a receive codebook of the user station.

15. An apparatus for beamforming training at a service and control point, comprising:
training sequence transmission means configured for transmitting training sequences to multiple user stations using switched transmit antenna weight vectors; and
antenna weight determination unit configured for determining optimum transmit antenna weight vectors of the service and control point based on channel information that is fed back from each user station of the multiple user stations and related to channel condition of own link and cross links of the each user station.

16. The apparatus according to claim 15, wherein the training sequence transmission means is further configured for transmitting training sequences to the multiple user stations using fixed transmit antenna weight vectors, such that the multiple user stations determine their respective optimum receive antenna weight vectors.

17. The apparatus according to claim 16, further comprising:
retraining determination means configured for determining whether to perform a retraining based on link quality between each user station of the multiple user stations and the service and control point, which is fed back from the each user station.

18. The apparatus according to claim 17, wherein the retraining is performed based on one of the optimum receive antenna weight vectors and the optimum transmit antenna weight vectors.

19. The apparatus according to claim 18, further comprising:
retraining preprocess means configured for dropping one or more user stations based on link leakage condition and/or indicating user stations to reset receive antenna weight vectors, in response to the determining to perform the re-training.

20. The apparatus according to claim 15, wherein the training sequences are orthogonal sequences.

21. The apparatus according to claim 20, wherein each of the training sequences comprises a complementary Golay sequence or a Zadoff-Chu sequence.

22. The apparatus according to claim 21, wherein each of the training sequences comprises at least one of a cyclic prefix and a cyclic postfix.

23. An apparatus for beamforming training at a user station, comprising:
training sequence receive means configured for receiving training sequences from a service and control point by using a fixed receive antenna weight vector;
channel information determination means configured for determining channel information related to channel condition of own link and cross links of the user station; and
channel information transmit means configured for transmitting the channel information to the service and control point.

24. The apparatus according to claim 23, wherein the training sequence receive means is further configured for receiving training sequences transmitted from the service and control point by using switched receive antenna weight vectors; and
the channel information determination means is further configured for determining channel information related to channel condition of own link and cross links of the user station; and
the apparatus further comprises:
weight vector determination means configured for determining an optimum receive antenna weight vector of the user station based on the channel information.

25. The apparatus according to claim 24, further comprising:
link quality evaluation means configured for evaluating link quality between the user station and the service and control pint based on the channel information; and
link quality transmit means configured to feed back the link quality to the service and control point.

26. The apparatus according to claim 25, further comprising:
weight vector resetting means configured for resetting the receive antenna weight vector as the optimum receive antenna weight vector in response to a receive antenna weight vectors resetting indication from the service and control point, so as to perform the re-training.

27. The apparatus according to claim 23, wherein the channel information for determining the optimum transmit antenna weight vectors is determined based on the fixed receive antenna weight vector of the user station, a multi-input multi-output channel impulse response, and a transmit codebook of the service and control point.

28. The apparatus according to claim 24, wherein the channel information for determining the optimum receive antenna weight vector is determined based on the fixed transmit antenna weight vectors of the service and control point, a multi-input multi-output channel impulse response, and a receive codebook of the user station.
